(19) United States
(12) Patent Application Publication
(10) Pub. No.: US 2001/0015973 A1
(43) Pub. Date: Aug. 23, 2001

(54) Connection control technique providing toll free calls

(75) Inventors: Akira Izumi, Tokyo (JP); Tatsuya Tsujii, Tokyo (JP); Haruhiko Okada, Osaka (JP)

Correspondence Address: YOUNG & THOMPSON, 745 SOUTH 23RD STREET 2ND FLOOR, ARLINGTON, VA, 22202

(73) Assignee: NEC Corporation

(21) Appl. No.: 09/790,508

(22) Filed: Feb. 23, 2001

(30) Foreign Application Priority Data
Feb. 23, 2000 (JP) 046493/2000

(51) Int. Cl. H04L 12/66

(52) U.S. Cl. 370/352

(57) ABSTRACT

A toll free service system allowing toll free calls to provide convenience to both companies and general users is disclosed. A source terminal makes a toll free call on a called party pays line on a circuit switched network. A plurality of servers is connected to the Internet. A signal converter connected to the called party pays line performs a signal conversion between a signal on the circuit switched network and an IP packet signal. A connection controller is connects the signal converter to the Internet and transmits a server selection menu to the source terminal. When a server is selected at the source terminal, the source terminal is connected to the selected server.

### BACKGROUND OF THE INVENTION

1. Field of the Invention

The present invention relates to a telecommunications system using called party pays lines, and in particular to a connection control method and system allowing toll free calls to a plurality of companies.

2. Description of the Related Art

In toll free call such as 800 service in United States or 0120 service in Japan, a company is billed for the communication charges on the called party pays line determined under an agreement with a common carrier and therefore callers are not charged for the communication service. This has made it quickly popular for the companies who can stimulate more calls and therefore more sales.

Recently, communication information processing functions in a communications network such as an intelligent network have been available and thereby it is possible to assign an easy-to-remember routing number that is different from the actually assigned routing number to the called party pays line. This causes the toll free calls to be increasingly widespread. In addition to voice communications, the trend has been to increase in data communications.

FIG. 1 shows a conventional toll free call services system, in which the server of each company is connected to a called party pays line dedicated to the company under contract. A general user uses a terminal 10 to dial a routing number corresponding to a called party pays line dedicated to a desired company on a circuit switched network 100. This causes the terminal 10 to be connected to the server 20 of the desired company via a corresponding signal converter 11, allowing voice and data communications through the established route. Since such a toll free call system is prepared for each company, a general user makes a call at the routing number of a desired company to communicate with its server.

However, for companies, it is necessary to sign a contract with each common carrier to install a called party pays line dedicated to each company on the circuit switched network 100. Further, to connect the server 20 of each company to the circuit switched network 100, a signal converter 11 dedicated to the company is needed. Furthermore, since the circuit switched network 100 employs a time-and-distance-base charging system, a long-distance call causes the company to incur an Increased charge for the communication.

On the other hand, for general users, it is not possible to communicate with a plurality of servers of different companies because a user must dial the routing number of each desired company. Therefore, the user cannot compare two or more items by displaying them on the same screen.

### SUMMARY OF THE INVENTION

An object of the present invention is to provide a connection control method and system allowing toll free calls to provide convenience to both companies and general users.

According to the present invention, a system includes: a source terminal making a toll free call on a called party pays line of a circuit switched network; a plurality of servers connected to an IP (Internet Protocol) network, allowing transmission and reception of information in IP packets; and a controller controlling connection of the source terminal to one of the servers depending on information received from the source terminal.

According to an aspect of the present invention, a system using a called party pays line on a circuit switched network, includes; a source terminal making a toll free call on the called party pays line; a plurality of servers connected to an IP (Internet Protocol) network, allowing transmission and reception of information in IP packets; a signal converter connected to an incoming port of the called party pays line, performing a signal conversion between a signal on the circuit switched network and an IP packet signal on the IP network; and a connection controller connecting the signal converter to the IP network, controlling connection of the source terminal to one of the servers depending on an instruction received from the source terminal.

The connection controller may transmit a server selection menu to the source terminal in response to an access from the source terminal, wherein a server to be connected to the source terminal is selected depending on a selection instruction of the server selection menu.

The connection controller may store a history of connection for a server that is connected to the source terminal.

The connection controller may store a routing address for each of the servers, wherein the connection controller transmits a server selection menu to the source terminal in response to an access from the source terminal, wherein, when a selection instruction on the server selection menu has been received from the source terminal, a selected server is connected to the source terminal using the routing address of the selected server.

The connection controller may further check whether a selected server depending on the instruction is authorized, wherein only when the selected server has been authorized, the selected server is connected to the source terminal.

According to another aspect of the present invention, a system using a called party pays line on a circuit switched network, includes: a source terminal making a toll free call on the called party pays line; a plurality of servers connected to an IP (Internet Protocol) network, allowing transmission and reception of information in IP packets; a signal converter connected to an incoming port of the called party pays line, performing a signal conversion between a signal on the circuit switched network and an IP packet signal on the IP network: and a connection controller connected between the signal converter and the IP network, controlling connection of the source terminal to one of the servers depending on area information included in identification information of the source terminal.

The connection controller may previously store a routing address and a connection acceptance area for each of the servers, wherein the area information is compared against previously stored connection acceptance areas to determine which one of the servers is connected to the source terminal.

In a toll free service system comprising: a source terminal making a toll free call on a called party pays line on a circuit switched network; a plurality of servers connected to an IP (Internet Protocol) network, allowing transmission and reception of information in IP packets; and a signal converter connected to an incoming port of the called party pays line, performing a signal conversion between a signal on the circuit switched network and an IP packet signal on the IP network, a connection control method includes the steps of: a) storing a routing address for each of the servers; b) transmitting a server selection menu to the source terminal in response to an access from the source terminal; and c) when a selection instruction on the server selection menu has been received from the source terminal, connecting a selected server to the source terminal using the routing address of the selected server.

The step (c) preferably includes the steps of: c.1) receiving the selection instruction on the server selection menu from the source terminal; c.2) checking whether a selected server depending on the selection instruction is authorized; c.3) when the selected server has been authorized, connecting the selected server to the source terminal.

A connection control method includes the steps of: a) previously storing a routing address and a connection acceptance area for each of the servers; b) receiving identification information of the source terminal in response to an access from the source terminal; c) extracting area information from the identification information of the source terminal; d) comparing the area information against previously stored connection acceptance areas; e) when a match is found, selecting a corresponding server as a connection destination; and f) connecting the corresponding server to the source terminal based on routing address of the corresponding server.

As described above, the called party pay line, the signal converter, and the connection controller are shared among a plurality of companies, resulting in reduced cost burden on each company.

Once a terminal has been connected to the connection controller via a called party pays line on the circuit switched network, it is possible to display information provided from one or more of a plurality of companies on the terminal without billing a general user for the communication charges. This allows a user to compare a plurality of items provided from different companies on the terminal, resulting in enhanced convenience to general users.

### BRIEF DESCRIPTION OF THE DRAWINGS

FIG. 1 is a diagram showing the configuration of a conventional toll free call service system;

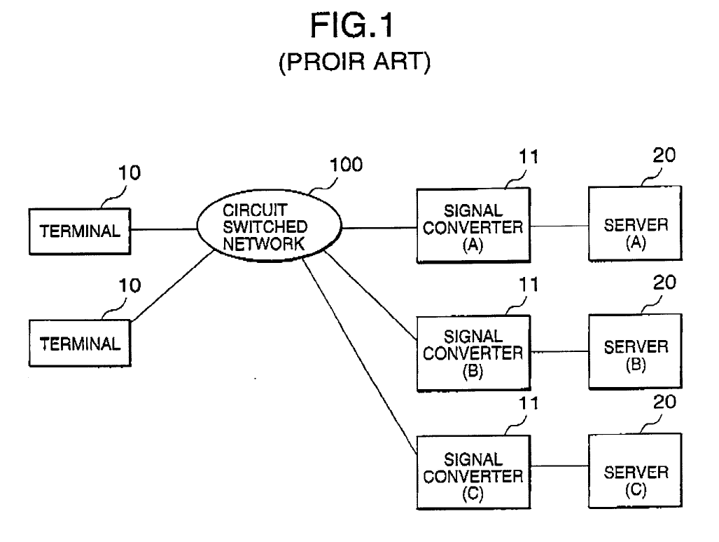

FIG. 2 is a diagram showing the schematic configuration of an embodiment of a toll free call service system according to the present invention;

FIG. 3 is a sequence diagram showing a first embodiment of a communication method according to the present invention;

FIG. 4 is a diagram showing a displayed image on a user's terminal in the case of FIG. 3;

FIG. 5 is a sequence diagram showing an operation of questionnaire case according to the first embodiment;

FIG. 6 is a diagram showing a displayed image on a user's terminal in the case of FIG. 5; and

FIG. 7 is a sequence diagram showing a third embodiment of a communication method according to the present invention.

### DESCRIPTION OF THE PREFERRED EMBODIMENTS

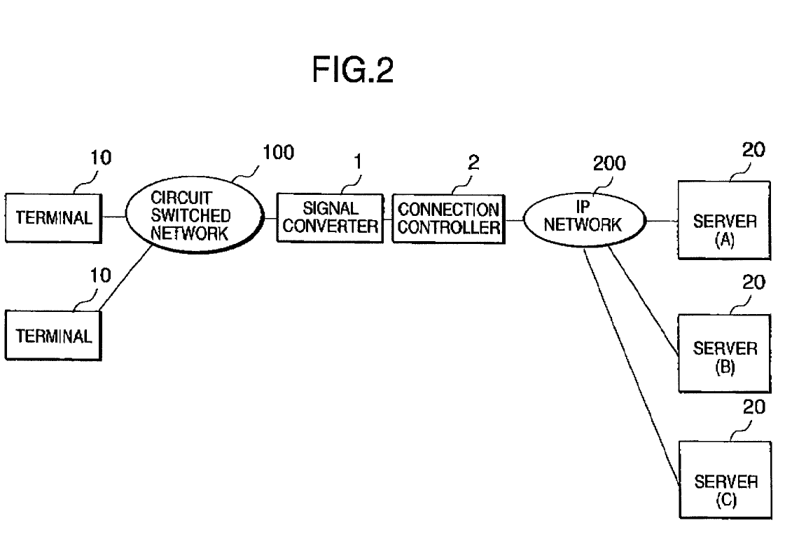

Referring to FIG. 2, a toll free service system according to the present invention uses not only a circuit switched network 100 such as the public telephone switched network but also an IP (Internet Protocol) network 200 such as the Internet to form a route between a terminal 10 and a user's desired company server 20. Further, the system is shared among a plurality of companies.

As shown In FIG. 2, when a general user uses a terminal 10 to make a toll free call at a predetermined routing number (here, telephone number), the terminal 10 is connected to a connection controller 2 via a called party pays line on the circuit switched network 100 and a signal converter 1. The signal converter 1 is connected to the incoming port of the called party pays line on the circuit switched network 100 and performs a conversion from voice and data signals on the circuit switched network 100 to IP packet signals on the IP network 200, and vice versa.

When having established a connection to the terminal 10 through the called party pays line on the circuit switched network 100, as described later, the connection controller 2 transmits a company selection menu to the terminal 10 to prompt the user to select one of companies (here, A, B, and C). When the user selects a desired company to transmit its information to the connection controller 2, the connection controller 2 accesses the user's desired company server 20 to allow voice and data communication between the terminal 10 and the user's desired company server 20.

Since this communication is made through the called party pays line on the circuit switched network 100, the user is not charged for the communication service and the company is billed for the communication charges on the called party pays line. The charging processing is performed by the connection controller 2.

Further, since a terminal 10 can be connected to a selected one of a plurality of company servers 20 using a single called party pays line on the circuit switched network 100, the user is allowed to perform voice and data communications with a plurality of companies without connecting the terminal 10 to each company server on the circuit switched network 100.

A terminal 10 may be an information processing device having a communication function, such as a personal computer or a mobile telephone. To enable voice and data communication with a company, the terminal 10 has an information displaying and entering function such that information provided by a company server 20 or the company selection menu provided by the connection controller 2 can be displayed on its monitor and necessary information can be input and transmitted as a response. Such an information displaying and entering function may be typically implemented by a browser. The information provided by a company may be advertisement for the company itself, merchandise, services, and the like dealt in by the company, product information including product name, type, price, specification, performance and the like, announcement of changes of specification and the like, and a prompt for prompting the user to enter information, such as a questionnaire or an application form for purchasing items.

A company server 20 may be Information processing equipment such as a workstation server and the like, which is installed by each company. As described before, the company server 20 has functions of transmitting information requested by a user to the user's terminal 10 and receiving information such as answers to the questionnaire or orders for products.

The signal converter 1 may be implemented in a communication device such as an access server that performs a conversion from voice and data signals on the circuit switched network 100 to IP packet signals on the IP network 200, and vice versa.

The connection controller 2 may be information processing equipment such as a workstation server and the like, which is used to control a connection between a terminal 10 and each of company servers 20. As described before, the connection controller 12 has functions of transmitting a company selection menu to a terminal 10 to which a connection has been established, connecting the terminal 10 to a user-desired company server 20, limiting the connection to a company server that is not permitted to be connected, and managing the connection to each company server to bill each company for the communication charges.

The connection controller 2 previously stores routing information of each of the company servers 20 so as to access a user's desired company server 20 on the IP network 200. As will be described later, the connection controller 2 may store connection area information for each server that is used to determine a company server depending on which area a source terminal is located in.

Operations

Taking the Internet as an example of the IP network 200, preferred embodiments of a telecommunication method according to the present invention will be described in detail.

Embodiment I

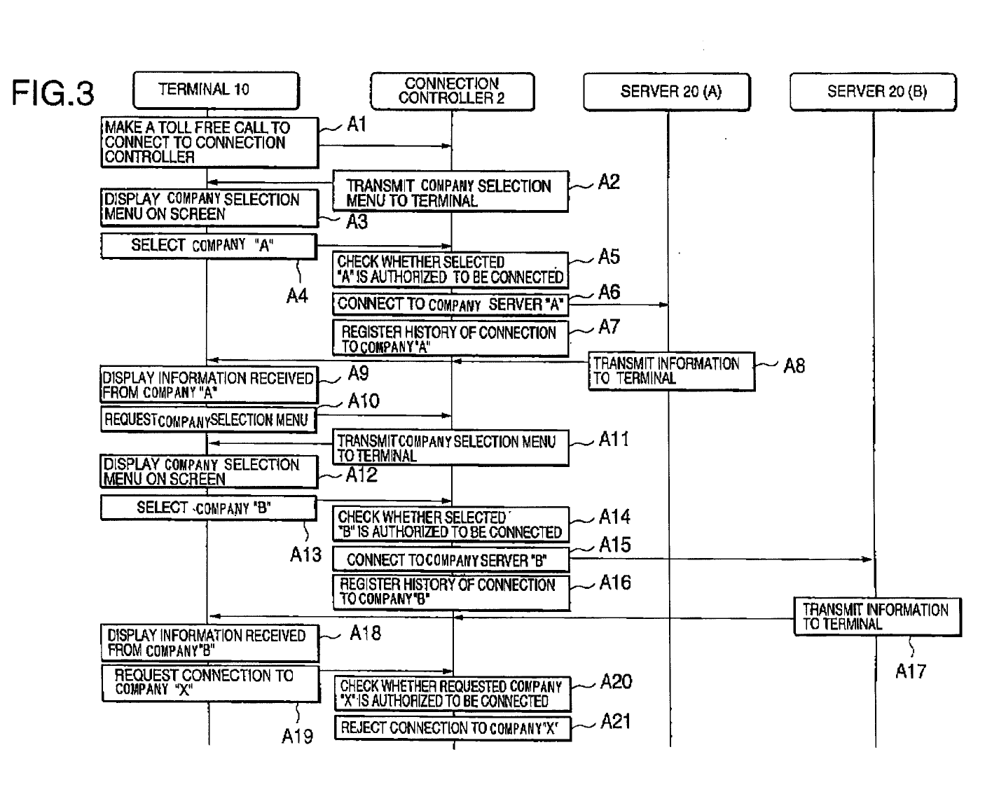

Referring to FIG. 3, a general user uses a terminal 10 to make a toll free call at a predetermined telephone number to the connection controller 2 via the circuit switched network 100 and the signal converter 1 (step A1). In response to the connection request, the connection controller 2 transmits a company selection menu back to the terminal 10 (step A2).

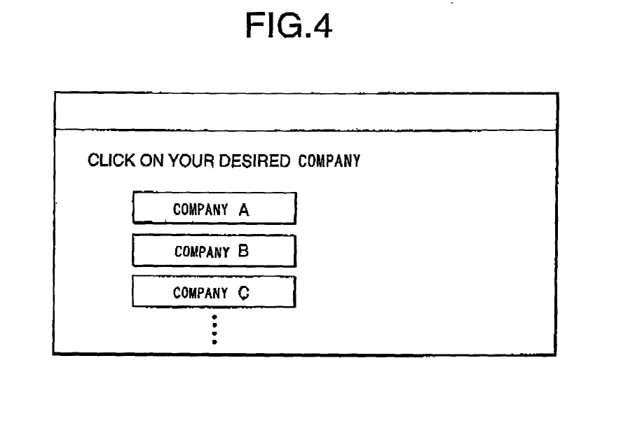

When the terminal 10 has received the company selection menu from the connection controller 2, the company selection menu as shown in FIG. 4 is displayed on the display device of the terminal 10 (step A3). The user clicks on a desired company button by using a pointing device such as a mouse (step A4). Here, the company “A” is assumed to be selected.

Upon receipt of company selection information from the terminal 10, the connection controller 2 checks whether the selected company “A” is authorized to be connected (step A5). In general, only authorized companies are included in the company selection menu. However, since the connection controller 2 bills each company for the communication charges, a strict check is preferably employed.

If it is determined that the selected company “A” is authorized, then the connection controller 2 connects to a company server 20 of the selected company “A” via the Internet 200 based on the routing information previously assigned to the company server 20 of the company “A” (step A6). At the same time, the connection controller 2 registers the history of connection to the company server 20 of the company “A” (step A7). More specifically, the history of connection includes the source subscriber number of a general user, the identification number of the connected server, the start time of the connection, the disconnection time, and the like, which are used as billing information for the company.

The company server 20 of the company “A” transmits information such as advertisement or the like to the terminal 10 via the connection controller 2 (step A8). At the terminal 10, the information received from the company server 20 of the company “A” is displayed (step A9),

In the case where the user further wants to access the server of another company, the user operates the terminal 10 to transmit a request for company selection menu to the connection controller 2 (step A10). In response to this request, the connection controller 2 transmits a company selection menu back to the terminal 10 (step A11).

When the terminal 10 has received the company selection menu from the connection controller 2, the company selection menu as shown in FIG. 4 is displayed on the display device of the terminal 10 (step A12). The user clicks on a desired company button by using a pointing device such as a mouse (step A13). Here, the company “B” is assumed to be selected.

Upon receipt of company selection information from the terminal 10, the connection controller 2 checks whether the selected company “B” is authorized to be connected (step A14). If it is determined that the selected company “B” is authorized, then the connection controller 2 connects to a company server 20 of the selected company “B” via the Internet 200 based on the routing information previously assigned to the company server 20 of the company “B” (step A15). At the same time, the connection controller 2 registers the history of connection to the company server 20 of the company “B” (step A16). More specifically, the history of connection includes the source subscriber number of a general user, the identification number of the connected server, the start time of the connection, the disconnection time, and the like. In such a case that the terminal 10 connects to a plurality of companies (here, “A” and “B”) in the same line on the circuit switched network 100, which are used as time-base billing information for each of the connected company servers.

The company server 20 of the company “B” transmits information such as advertisement or the like to the terminal 10 via the connection controller 2 (step A17). At the terminal 10, the information received from the company server 20 of the company “B” is displayed preferably together with the information of the company “A” previously received (step A18).

In the case where the user further wants to access the server of another company “X” who is not authorized, the user operates the terminal 10 to directly transmit a request for connection to the company “X” to the connection controller 2 without using the company selection menu (step A19).

Upon receipt of the connection request from the terminal 10, the connection controller 2 checks whether the designated company “X” is authorized to be connected (step A20). Since the company “X” is not authorized, the connection controller 2 rejects the connection request to the company “X” (step A21).

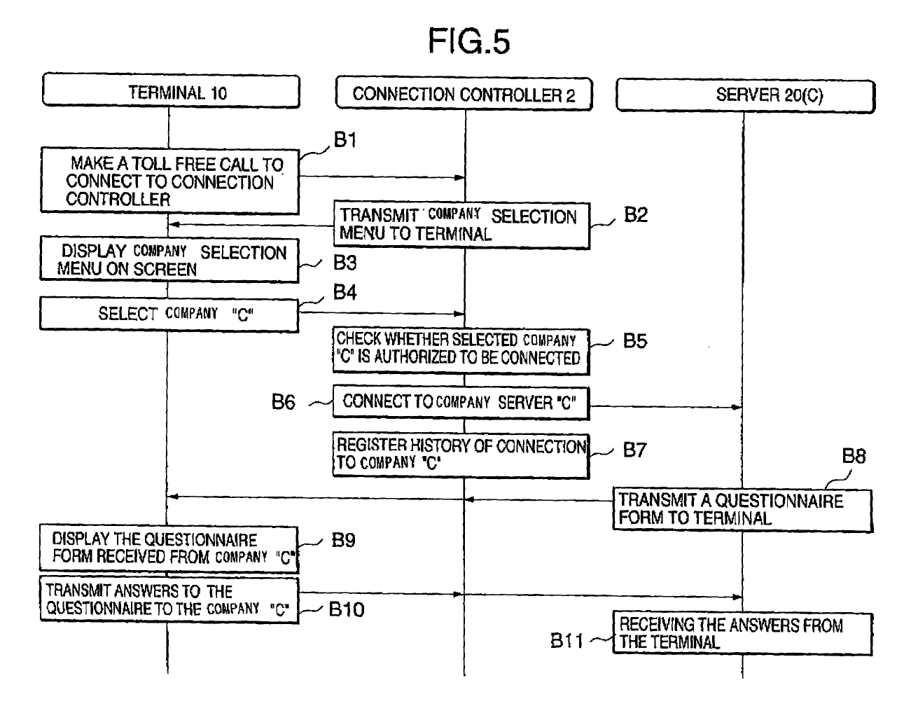

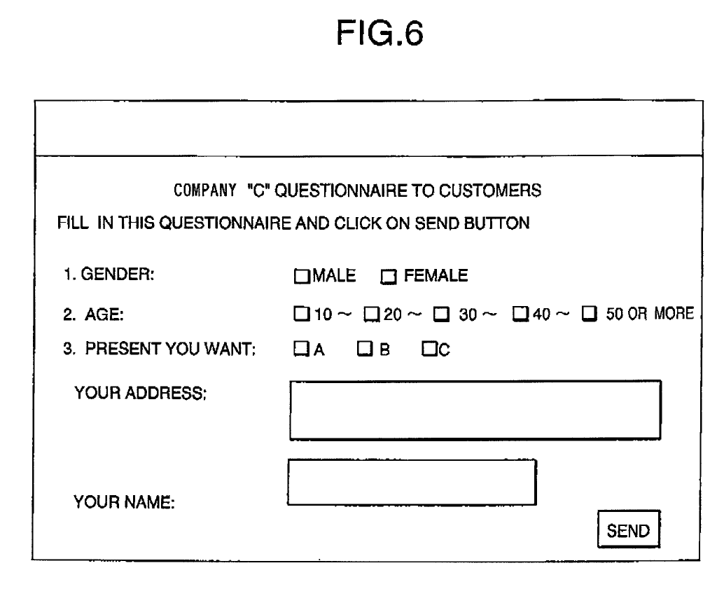

Hereafter, a questionnaire case will be described with reference to FIGS. 5 and 6. In this case, a terminal 10 connects to a company server 20 of a company “C” and then the general user answers to the questionnaire received from the company “C”.

Referring to FIG. 5, steps B1 through B7 are basically similar to the steps A1 through A7 of FIG. 3, respectively, and therefore the details are omitted.

When the connection controller 2 connects to the company server 20 of the selected company “C” via the Internet 200 based on the routing information previously assigned to the company server 20 of the company “C” (step B6), the company server 20 of the company “C” transmits information of a questionnaire to the terminal 10 via the connection controller 2 (step B8). At the terminal 10, the questionnaire received from the company server 20 of the company “C” is displayed (step B9). An example of the questionnaire is shown in FIG. 6.

After having filled In the questionnaire using a pointing device and a keyboard, the user clicks on the send button to transmit the answer to the questionnaire from the terminal 10 to the company server 20 of the company “C” (step B10). The company “C” can receive the answer to the questionnaire from a general user (step B11).

In this manner, a company can provide general users with information and further collect desired information from many general users. In the case of purchasing products, an application form for purchase is used in place of a questionnaire. If the company server is provided with questionnaire totaling function or order slip creation function, office automation can be promoted.

Embodiment II

When a general user uses a terminal 10 to make the toll free call, the signal converter 1 receives the subscriber identification information of the general user from the circuit switched network 100. Based on the subscriber identification information, the connection controller 2 can determine a company server 20 to be connected to the source terminal 10. In this embodiment, the connection controller 2 previously stores connection acceptance area information for each company server.

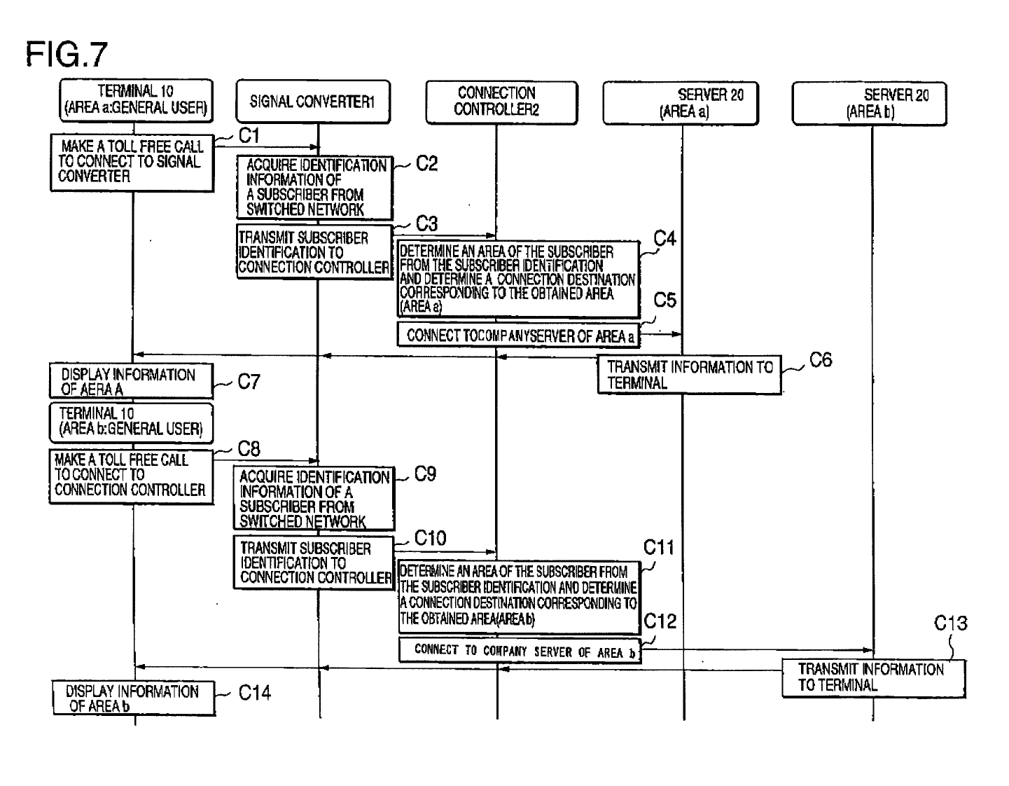

Referring to FIG. 7, a general user uses a terminal 10 located at an area a to make a toll free call at a predetermined telephone number to the signal converter 1 via the circuit switched network 100 (step C1). The signal converter 1 receives the subscriber identification number such as a telephone number of the general user from the circuit switched network 100 (step C2) and transmits the subscriber identification number to the connection controller 2 (step C3)

The connection controller 2 extracts the area code (here, area a) from the subscriber identification number and determines a company server 20 to be connected to the terminal 10 depending on the extracted area code (step C4). More specifically, the extracted area code is compared against previously stored connection acceptance area codes each corresponding to the company servers and, if a match is found, then it is determined that a corresponding company server should be connected to the source terminal. The connection controller 2 connects to the determined company server 20 via the Internet 200 based on the routing information previously assigned to the company server 20 (step C5).

How to determine a company server to be connected to a source terminal can be arbitrarily determined so as to enhance convenience to a general user on service of the company server. A company server to be connected may be changed depending on various conditions including which area, what time, and what day.

In response to the connection request from the connection controller 2, the company server 20 of the area a transmits information of the area a to the terminal 10 of the same area a via the connection controller 2 (step C6). At the terminal 10, the information received from the company server 20 is displayed (step C7).

It is the same with a terminal 10 located at another area b. Steps C8 through C14 for the area b are basically similar to the steps C1 through C7, respectively. Since the area code is b, the connection controller 2 extracts the area code b from the subscriber identification number of the terminal 10 and determines a company server 20 to be connected to the terminal 10 depending on the extracted area code (step C11). The connection controller 2 connects to the determined company server 20 of the area code b via the Internet 200 based on the routing information previously assigned to the company server 20 (step C12) In response to the connection request from the connection controller 2, the company server 20 of the area b transmits information of the area b to the terminal 10 of the same area b via the connection controller 2 (step C13). At the terminal 10 of the area b, the information received from the company server 20 is displayed (step C14).

In this manner, a company server to be connected as a destination is automatically determined depending on where a source terminal is located.

A company server in the above embodiments is not limited to a server of a private company. The company server may be a server for providing information of local self-governing body, school, public institute, public company, or the like. Further, the company server can be shared among a plurality of local retail stores or small-size companies so that it is used as an inserted bill.

1. A system comprising:
a source terminal making a toll free call on a called party pays line of a circuit switched network;
a plurality of servers connected to an IP (Internet Protocol) network, allowing transmission and reception of information in IP packets; and
a controller controlling connection of the source terminal to one of the servers depending on information received from the source terminal.

2. A system using a called party pays line on a circuit switched network, comprising:
a source terminal making a toll free call on the called party pays line;
a plurality of servers connected to an IP (Internet Protocol) network, allowing transmission and reception of information in IP packets;
a signal converter connected to an incoming port of the called party pays line, performing a signal conversion between a signal on the circuit switched network and an IP packet signal on the IP network; and
a connection controller connecting the signal converter to the IP network, controlling connection of the source terminal to one of the servers depending on an instruction received from the source terminal.

3. The system according to claim 2, wherein the connection controller transmits a server selection menu to the source terminal in response to an access from the source terminal, wherein a server to be connected to the source terminal is selected depending on a selection instruction of the server selection menu.

4. The system according to claim 2, wherein the connection controller stores a history of connection for a server that is connected to the source terminal.

5. The system according to claim 2, wherein the connection controller stores a routing address for each of the servers, wherein the connection controller transmits a server selection menu to the source terminal in response to an access from the source terminal, wherein, when a selection instruction on the server selection menu has been received from the source terminal, a selected server is connected to the source terminal using the routing address of the selected server.

6. The system according to claim 2, wherein the connection controller further checks whether a selected server depending on the instruction is authorized, wherein only when the selected server has been authorized, the selected server is connected to the source terminal.

7. A system using a called party pays line on a circuit switched network, comprising:
a source terminal making a toll free call on the called party pays line;
a plurality or servers connected to an IP (Internet Protocol) network, allowing transmission and reception of information in IP packets;
a signal converter connected to an incoming port of the called party pays line, performing a signal conversion between a signal on the circuit switched network and an IP packet signal on the IP network; and
a connection controller connected between the signal converter and the IP network, controlling connection of the source terminal to one of the servers depending on area information included in identification information of the source terminal.

8. The system according to claim 7, wherein the connection controller previously stores a routing address and a connection acceptance area for each of the servers, wherein the area information is compared against previously stored connection acceptance areas to determine which one of the servers is connected to the source terminal.

9. The system according to claim 7, wherein the connection controller stores a history of connection for a server that is connected to the source terminal.

10. A connection control method in a toll free service system comprising:
a source terminal making a toll free call on a called party pays line on a circuit switched network;
a plurality of servers connected to an IP (Internet Protocol) network, allowing transmission and reception of information in IP packets; and
a signal converter connected to an incoming port of the called party pays liner performing a signal conversion between a signal on the circuit switched network and an IP packet signal on the IP network,
the method comprising the steps of:
a) storing a routing address for each of the servers;
b) transmitting a server selection menu to the source terminal in response to an access from the source terminal; and
c) when a selection instruction on the server selection menu has been received from the source terminal, connecting a selected server to the source terminal using the routing address of the selected server.

11. The method according to claim 10, wherein the step (c) comprises the steps of:
c.1) receiving the selection instruction on the server selection menu from the source terminal;
c.2) checking whether a selected server depending on the selection instruction is authorized;
c.3) when the selected server has been authorized, connecting the selected server to the source terminal.

12. The method according to claim 10, further comprising the step of:
d) storing a history of connection for the selected server connected to the source terminal.

13. A connection control method in a toll free service system comprising:
a source terminal making a toll free call on a called party pays line on a circuit switched network;
a plurality of servers connected to an IP (Internet Protocol) network, allowing transmission and reception of information in IP packets, and
a signal converter connected to an incoming port of the called party pays line, performing a signal conversion between a signal on the circuit switched network and an IP packet signal on the IP network,
the method comprising the steps of:
a) previously storing a routing address and a connection acceptance area for each of the servers;
b) receiving identification information of the source terminal in response to an access from the source terminal;
c) extracting area information from the identification information of the source terminal;
d) comparing the area information against previously stored connection acceptance areas;
e) when a match is found, selecting a corresponding server as a connection destination; and
f) connecting the corresponding server to the source terminal based on routing address of the corresponding server.
